(19) United States
(12) Patent Application Publication
(10) Pub. No.: US 2023/0127547 A1
(43) Pub. Date: Apr. 27, 2023

(54) SMART UNLOADING OF IMPLEMENT HEAD ON TRAILER

(71) Applicant: DEERE & COMPANY, MOLINE, IL (US)

(72) Inventors: NISHANT N. KHARCHE, PUNE (IN); Sarvesh Aundhkar, Kolhapur (IN); VISHAL V. RANE, PUNE (IN); BRADLEY K. YANKE, Eldridge, IA (US)

(21) Appl. No.: 17/452,077

(22) Filed: Oct. 25, 2021

(51) Int. Cl. B60W 30/18; A01D 75/00; G01S 19/42; B60R 1/00; B60W 10/20; B60W 10/04; B60W 10/30

(52) U.S. Cl. CPC B60W 30/18036; A01D 75/002; G01S 19/42; B60R 1/00; B60W 10/20; B60W 10/04; B60W 10/30; B60W 2510/20; B60W 2520/00; B60W 2420/42; B60R 2300/20; B60R 2300/10; B60W 2300/158

(57) ABSTRACT

An implement head transportation includes an implement head, a traction unit, and a trailer. The traction unit is configured to receive and support the implement head for operation of the implement head. The trailer is configured to receive and support the implement head for transportation of the implement head between locations. The trailer includes a frame including information related to an implement placement location on the frame. The traction unit includes a controller operable to sense data from the trailer related to the implement placement location on the frame, and generate a guide signal. The guide signal guides the traction unit relative to the trailer to position the implement head on the implement placement location of the frame when transferring the implement head from the traction unit to the trailer.

### TECHNICAL FIELD

The disclosure generally relates to an implement head transportation system for transporting an implement head of a harvester implement. The implement head transportation system includes a trailer and the harvester implement, and with the harvester implement including the implement head and a traction unit.

### BACKGROUND

Some harvester implements include a traction unit and an attachable implement head. The implement head is attachable to the traction unit. The traction unit provides motive power to maneuver the harvester implement through a field and operate the implement head. The implement head performs a harvest operation on crop material in the field as the harvester implement maneuvers through the field.

The implement head may define a width perpendicular to a direction of travel of the traction unit that is greater than an allowable width permitted on roadways, and/or that makes transporting the traction unit with the implement head attached impracticable. In order to transport the implement head, the implement head may be positioned on a trailer with a long dimension of the implement head extending parallel with a long dimension of the trailer, such that the width of the implement head is arranged to be parallel with the roadway. The trailer may then be hauled between locations, by the traction unit or some other vehicle. The combination of the trailer, the traction unit, and the implement head may be considered an implement head transportation system. In order to transport the implement head on the trailer, the implement head must be transferred from the traction unit onto the trailer, and positioned on the trailer at a desired location on the trailer. Properly positioning the implement head in the correct position on the trailer may require a high level of operator skill and/or experience.

### SUMMARY

An implement head transportation system is provided. The implement head transportation system includes an implement head, a traction unit, and a trailer. The traction unit is configured to receive and support the implement head for operation of the implement head. The trailer is configured to receive and support the implement head for transportation of the implement head between locations. The trailer includes a frame The traction unit includes a controller including a processor and a memory having an unloading algorithm stored therein. The processor is operable to execute the unloading algorithm to sense data from the trailer related to the implement placement location on the frame. The processor may then determine an implement placement location from the data sensed from the trailer and generate a guide signal. The guide signal is configured for guiding the traction unit relative to the trailer to position the implement head on the implement placement location of the frame when transferring the implement head from the traction unit to the trailer.

In one implementation of the disclosure, the trailer may include a marker. The marker includes the information related to the implement placement location on the frame. In other implementations, the physical dimension of the frame may provide the data related to the implement placement location.

In one implementation of the disclosure, the marker may include a visual fiducial marker. The visual fiducial marker may include a tag, sticker, paint mark, etc., having indicia thereon or otherwise conveying data, that may be used as a point of reference or a measure. In one implementation, the marker may include, but is not limited to, an AprilTag™, or other similar device. In one implementation, the marker includes indicia or data indicating a three-dimensional location relative to the frame. The three-dimensional location corresponds to the implement placement location.

In one implementation of the disclosure, the processor may be configured to sense the data related to the implement placement location from the marker. In another implementation of the disclosure, the processor may be configured to sense the data related to the implement placement location from the physical dimensions and construction of the frame.

In one implementation of the disclosure, the implement placement location includes an implement boundary region. The implement boundary region may be defined to correspond with an exterior periphery of the implement head, or with a region on the trailer configured to support the implement head. The marker may include data related to a three-dimensional location of the implement boundary region, or may otherwise define or outline the three dimensional location of the implement boundary region.

In one aspect of the disclosure, the processor is operable to execute the unloading algorithm to determine a placement center location of the implement boundary region, and determine a placement center location of the implement head. The placement center location of the implement boundary region may be defined as the geometric center of the implement boundary region on a surface designed to support the implement head. The placement center location of the implement head may be considered or defined to include, but is not limited to, a geometric center of the implement head, or a center of gravity of the implement head. The guide signal may include guidance to position the implement head within the implement boundary region, such that the placement center location of the implement head is positioned on the placement center location of the implement boundary region.

In one aspect of the disclosure, the traction unit may include a trailer sensor. The trailer sensor is disposed in communication with the controller and positioned to detect the marker. The trailer sensor communicates data detected from the trailer to the controller. The data may include, but is not limited to, a shape, a color, image, size, etc. The trailer sensor may include, but is not limited to, an optical sensor. The optical sensor may include, but is not limited to, a camera system, such as but not limited to a stereo camera. For example, in one implementation, the trailer sensor may detect data from marker related to the implement placement location. In another implementation, the trailer sensor may capture an image of the frame of the trailer, and analyze the image to determine the implement placement location.

In one aspect of the disclosure, the traction unit may include a location sensor. The location sensor is disposed in communication with the controller and operable to sense data related to one of a geographic location of the traction unit and/or a ground speed of the traction unit relative to the implement placement location. The location sensor communicates the detected data to the controller. In one implementation of the disclosure, the location sensor may include, but is not limited to, a Global Positioning Satellite (GPS) sensor. The GPS sensor detects signals from multiple satellites. The controller may use the signals form the multiple satellites to determine a geographic location of a fixed point on the traction unit. If the position of the traction unit is tracked over a period of time, the controller may calculate the ground speed of the traction unit.

In one aspect of the disclosure, the traction unit may include a steering angle sensor. The steering angle sensor is operable to detect data related to a current position of a steering system of the traction unit. The steering angle sensor may communicate the sensed data to the controller. In one aspect of the disclosure, the traction unit may include a speed sensor. The speed sensor is operable to detect data related to the ground speed of the traction unit. The speed sensor may communicate the sensed data to the controller. The controller may use the data from the steering angle sensor and/or the data from the speed sensor to determine and/or define the guide signal.

In one implementation of the disclosure, the guide signal may include a communication signal for a visual display of the traction unit. The visual display may be configured to communicate an operating command to an operator of the traction unit. For example, the visual display may include a screen mounted in an operator's station of the traction unit. The communication signal may indicate operating commands to the operator. The operating commands may include instructions for controlling one or more operating systems of the traction unit. For example, the operating commands may include move forward, turn left, turn right, raise the implement head, lower the implement head, etc. The operator of the traction unit may follow the operating commands to position the implement head on the implement placement location. By so doing, the controller may use the marker on the trailer to identify the implement placement location, determine the proper operating commands required to position the implement head on the implement placement location, and provide those operating commands to the operator. The operator may then follow the operating commands to properly position the implement head on the trailer.

In another implementation of the disclosure, the guide signal may include a control signal for controlling an operating system of the traction unit. The operating system of the traction unit may include, but is not limited to, a propulsion system operable to control a ground speed of the traction unit, a steering system operable to control a direction of travel of the traction unit, and a lift system operable to control a vertical position of the implement head relative to the traction unit. The controller may communicate the control signal to one or more of the operating systems of the traction unit to autonomously control the traction unit and move the implement head onto the implement placement location.

A trailer for transporting an implement head of a harvester implement is also provided. The trailer includes a frame. A marker may be disposed on the frame. The marker includes data defining an implement boundary region on the frame. The implement boundary region is a position on the frame configured for supporting the implement head.

In one implementation of the disclosure, the marker includes a visual fiducial marker indicating a three-dimensional location relative to the frame. The three-dimensional location relates to the implement placement location. For example, the marker may include, but is not limited to, an AprilTag™, or other similar device or marking.

A traction unit for a harvester implement is also provided. The traction unit includes a chassis. The chassis rotatably supports at least one ground engaging element. The chassis is configured to receive and support an implement head in an operating position. The traction unit further includes a propulsion system, a steering system, and a lift system. The propulsion system is operable to rotate the ground engaging element for moving the chassis relative to ground surface at a ground speed. The steering system is operable to control a direction of travel of the chassis. The lift system is operable to control a vertical height of the implement head relative to the ground surface. The traction unit further includes a controller. The controller includes a processor and a memory having an unloading algorithm stored therein. The processor is operable to execute the unloading algorithm to sense data from the trailer. The data is related to an implement placement location on the trailer. The controller may then generate a guide signal for guiding the chassis relative to the trailer to position the implement head on the implement placement location of the trailer when transferring the implement head from the chassis to the trailer.

In one implementation of the disclosure, the trailer may be equipped with a marker. The marker may include the data related to the implement placement location. In another implementation of the disclosure, the structure shape, size and construction of the frame may provide the data related to the implement placement location.

In one aspect of the disclosure, the traction unit may include a trailer sensor. The trailer sensor is disposed in communication with the controller, and is operable to sense the data from the marker and communicate that data to the controller. In one implementation, the trailer sensor may include an optical sensor. For example, the trailer sensor may include, but is not limited to, a stereo camera. The controller may use the data sensed from the frame and/or the marker to determine or generate the guide signal. For example, the data may include data coded and/or stored with the marker. In another example, the data may include the structure shape, size and construction of the frame.

In one aspect of the disclosure, the traction unit may include other sensors, and the controller may receive other data related to the position and/or operation of the traction unit from these other sensors, and use this other data to generate the guide signal. For example, the traction unit may include a ground speed sensor for detecting a ground speed of the traction unit, a location sensor for detecting a geographic location of the traction unit relative to the trailer, and/or a steering angle sensor for detecting a current position of a steering system of the traction unit.

A method of unloading an implement head from a traction unit onto a trailer is also provided. The method includes sensing data from the trailer with a trailer sensor disposed on the traction unit. The data from the trailer relates to an implement placement location on the trailer. A position of the implement head relative to the implement placement location may then be determined with a location sensor disposed on the traction unit. A controller of the traction unit may then generate a guide signal. The guide signal is configured to guide the traction unit relative to the trailer to position the implement head on the implement placement location of the frame when transferring the implement head from the traction unit to the trailer.

In one implementation of the method, the trailer may include a marker including information related to the implement placement location. The step of sensing data from the trailer may include sensing data from the marker.

In one aspect of the method disclosed herein, the traction unit is maneuvered in response to the guide signal to position the implement head on the implement placement location of the trailer. The traction unit may be maneuvered manually by an operator, or may be maneuvered autonomously based on the guide signal.

In one aspect of the disclosure, once the implement head is positioned over the implement placement location, the implement head may be lowered onto the trailer via the lift system of the traction unit, thereby transferring support of the implement head from the traction unit to the trailer.

In one aspect of the disclosure, once the implement head is supported by the trailer, the implement head may be detached from the traction unit to complete transfer of the implement head from the traction unit to the trailer.

In one aspect of the disclosure, the marker may include, but is not limited to, a visual fiducial marker providing data indicating a three-dimensional location relative to the trailer. The three-dimensional location may include the implement placement location on the trailer. In one aspect of the disclosure, the implement placement location may include an implement boundary region corresponding to an exterior periphery of the implement head. As such, the marker may include data related to a three-dimensional location of the implement boundary region.

In one implementation of the disclosure, the data related to the implement placement location may include the physical size, shape, and construction of the frame. The data may be sensed from the trailer by capturing an image of the frame. The process may further include analyzing the image to determine the implement placement location on the frame.

In one aspect of the method described herein, the controller may determine a placement center location of the implement boundary region on the trailer, and further determine a placement center location of the implement head. The placement center location of the implement boundary region may be defined as the geometric center of the implement boundary region on a surface designed to support the implement head. The placement center location of the implement head may be considered or defined to include, but is not limited to, a geometric center of the implement head, or a center of gravity of the implement head. The guide signal is configured to guide the traction unit relative to the trailer such that the placement center location of the implement head is aligned with the placement center location of the implement boundary region on the trailer.

In one implementation of the method described herein, the guide signal includes a communication signal for a visual display of the traction unit. The visual display may be configured to communicate an operating command to an operator of the traction unit. For example, the visual display may include a screen mounted in an operator's station of the traction unit. The communication signal may indicate operating commands to the operator. The operating commands may include instructions for controlling one or more operating systems of the traction unit. For example, the operating commands may include move forward, turn left, turn right, raise the implement head, lower the implement head, etc. The operator of the traction unit may follow the operating commands to position the implement head on the implement placement location. By so doing, the controller may use the marker on the trailer to identify the implement placement location, determine the proper operating commands required to position the implement head on the implement placement location, and provide those operating commands to the operator. The operator may then follow the operating commands to properly position the implement head on the trailer.

In another implementation of the method described herein, the guide signal may include a control signal for controlling an operating system of the traction unit. The operating system of the traction unit may include, but is not limited to, a propulsion system operable to control a ground speed of the traction unit, a steering system operable to control a direction of travel of the traction unit, and a lift system operable to control a vertical position of the implement head relative to the traction unit. The controller may communicate the control signal to one or more of the operating systems of the traction unit to autonomously control the traction unit and move the implement head onto the implement placement location.

In one aspect of the method described herein, the controller may be configured to determine a ground speed of the traction unit relative to the trailer. The controller may determine the ground speed using an appropriate sensor. For example, in one implementation, the traction unit may include a speed sensor configured to sense data related to the ground speed of the traction unit. The controller may receive this data and thereby determine the ground speed. In other implementations, the traction unit may include a GPS sensor. The controller may determine and track a geographic location of the traction unit over time, based on the data from the GPS sensor, to determine the ground speed of the traction unit. The controller may then use the ground speed of the traction unit to generate the guide signal.

In one aspect of the method described herein, the controller may be configured to determine a location of the traction unit and/or the implement head attached to the traction unit relative to the trailer. The traction unit may include a location sensor configured to sense data related to the location of the traction unit relative to the trailer. For example, in one implementation, the traction unit may include a radar sensor, a Lidar sensor, or a camera operable to detect data related to a position of the trailer relative to the traction unit. Additionally, the traction unit may include a GPS sensor operable to determine a location of the traction unit. The controller may then use the location of the traction unit and/or the implement head relative to the trailer to generate the guide signal.

In one aspect of the method described herein, the controller may be configured to determine a direction of travel of the traction unit relative to the trailer. The traction unit may include a steering angle sensor configured to sense a current position of the steering system. The controller may use the data from the steering angle sensor to determine the current position of the steering system. The controller may then use the current position of the steering system to generate the guide signal.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of an implement head transportation system showing an implement head attached to a traction unit prior to unloading the implement head onto a trailer.

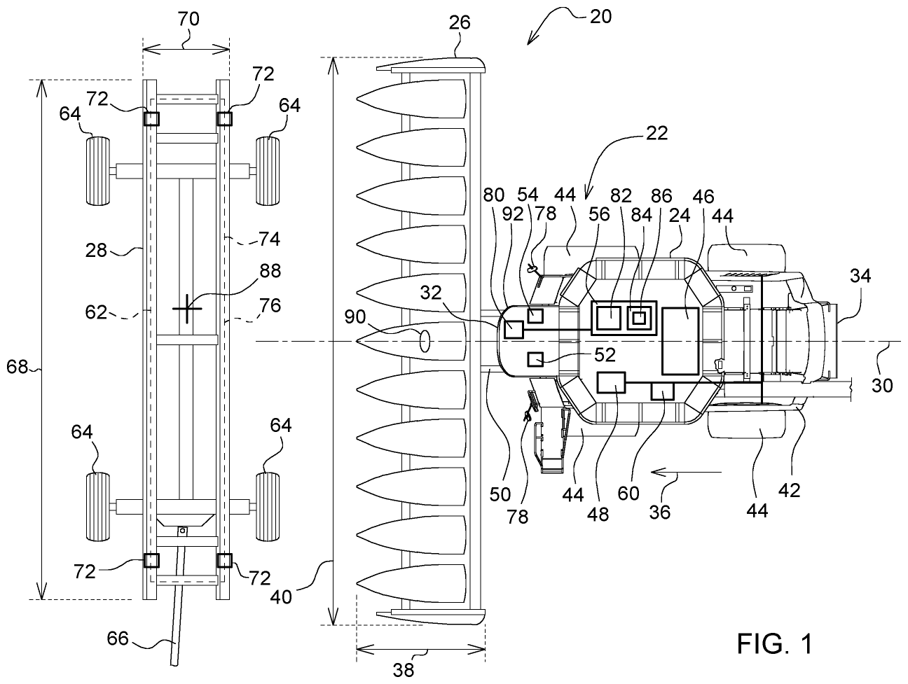

FIG. 2 is a schematic perspective view of the implement head transportation system showing the implement head attached to the traction unit prior to unloading the implement head onto the trailer.

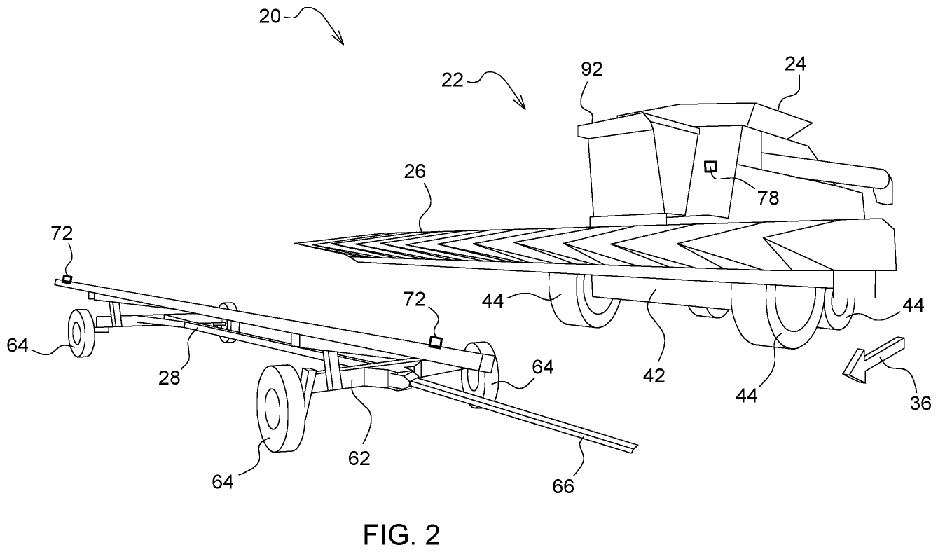

FIG. 3 is a schematic perspective view of the implement head transportation system showing the implement head positioned above a placement center location of the trailer.

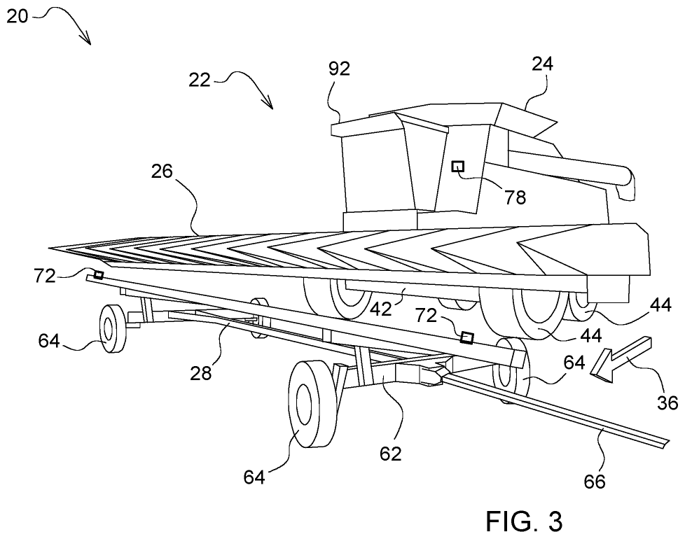

FIG. 4 is a schematic perspective view of the implement head transportation system showing the implement head supported on the trailer while attached to the traction unit.

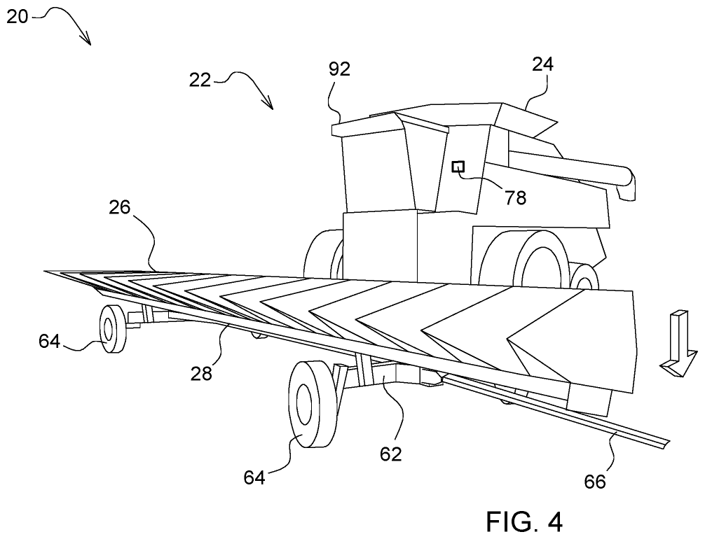

FIG. 5 is a schematic perspective view of the implement head transportation system showing the implement head supported on the trailer with the traction unit detached and withdrawn away from the implement head.

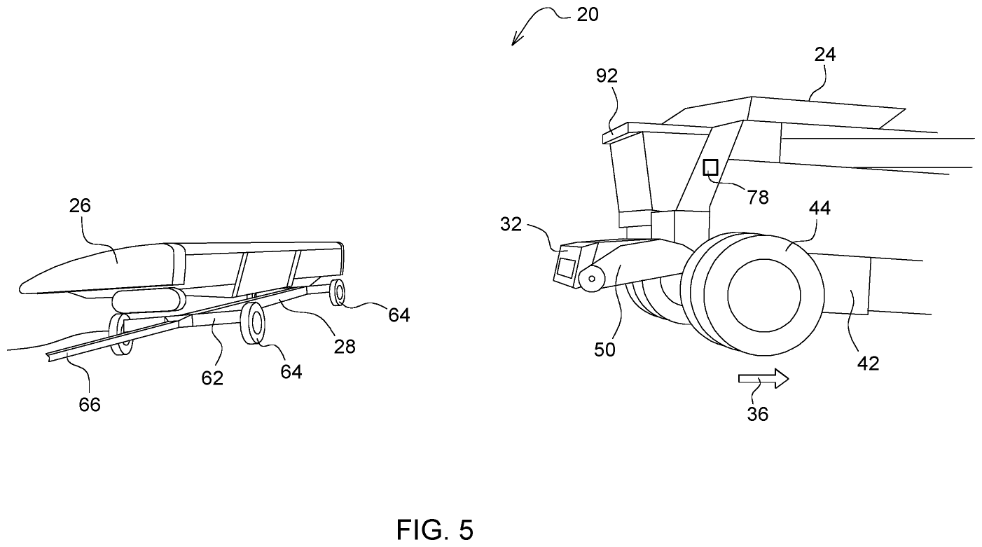

FIG. 6 is a schematic perspective view of the trailer.

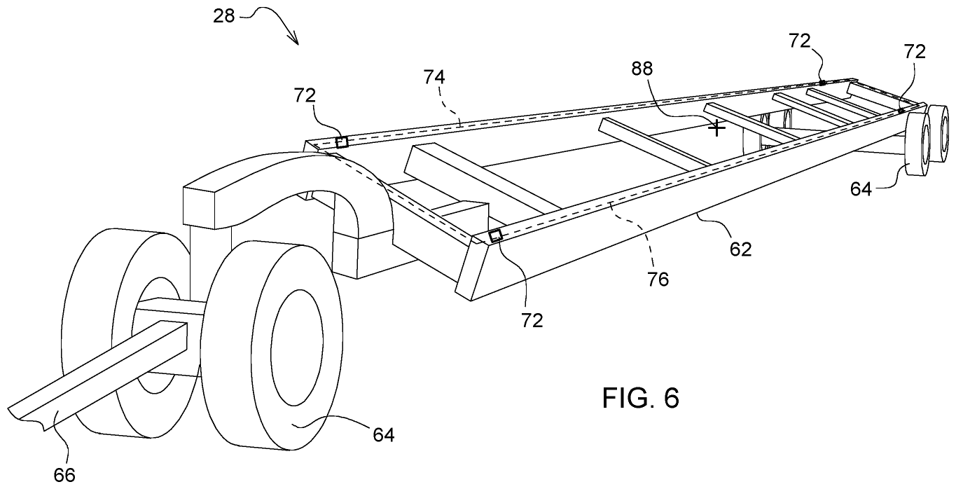

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

Referring to the Figures, wherein like numerals indicate like parts throughout the several views, an implement head transportation system is generally shown at 20. The implement head transportation system 20 may be used to transport a harvester implement 22 between fields. The harvester implement 22 may include a traction unit 24 and an implement head 26. The implement head transportation system 20 includes the harvester implement 22, i.e., the traction unit 24 and the implement head 26, as well as a trailer 28.

The implement head 26 may be removably attached to the traction unit 24. The implement head 26 may be attached to the traction unit 24 in any suitable manner. Generally, one or more latches, hooks, or other mechanical coupling devices may be engaged to secure the implement head 26 to the traction unit 24. The specific manner and structural components used to attach the implement head 26 to the traction unit 24 are known to those skilled in the art, are not pertinent to the teachings of this disclosure, and are therefore not described in greater detail herein.

The implement head 26 is operable to perform a harvesting operation on a crop in a field. The crop may include, but is not limited to, small and large grains, hay, stalks, biomass, etc. The implement head 26 may include, but is not limited to, a corn head, a draper head, an auger platform head, a belt pick-up head, a cutter head, a mower head, etc. The specific type of harvesting operation, e.g., cutting, mowing, gathering, reaping, the specific type of crop material, as well as the specific construction and operation of the implement head 26 are not pertinent to the teachings of this disclosure, and are therefore not described in greater detail herein.

The traction unit 24 extends along a central longitudinal axis 30, between a forward end 32 and a rearward end 34 relative to a direction of travel 36 while performing the harvesting operation. The implement head 26 includes a head length 38 and a head width 40. The head length 38 and the head width 40 of the implement head 26 is defined herein with reference to the central longitudinal axis 30 of the traction unit 24. As such, the head width 40 of the implement head 26 as defined herein refers to a dimension of the implement head 26 measured perpendicular to the central longitudinal axis 30 of the traction unit 24 when the implement head 26 is attached to the traction unit 24, whereas the head length 38 of the implement head 26 as defined herein refers to a dimension of the implement head 26 measured parallel to the central longitudinal axis 30 of the traction unit 24 when the implement head 26 is attached to the traction unit 24. The head width 40 of the implement head 26 may exceed a maximum allowable width permitted on roadways. As such, the implement head 26 may not be transported on roadways when attached to the traction unit 24 in the harvest operation position. As such, in order to transport the implement head 26 on a roadway, the implement head 26 may be loaded onto the trailer 28 in an orientation allowing for legal transport on the roadway, and then transported between locations.

The traction unit 24 is configured to receive and support the implement head 26 for operation of the implement head 26. The traction unit 24 may include a moveable platform appropriate for the specific construction of the implement head 26. For example, the traction unit 24 may include, but is not limited to, a combine harvester, a tractor, a self-propelled windrower, a forage harvester, etc. The traction unit 24 includes a chassis 42 rotatably supporting at least one ground engaging element 44. The ground engaging elements 44 may include, but are not limited to, tires or tracks. The chassis 42 is configured to receive and support the implement head 26.

The traction unit 24 may further one or more different operating systems 46, 48, 50. The different operating systems 46, 48, 50 may include, but are not limited to, a propulsion system 46, a steering system 48, or a lift system 50. The propulsion system 46 may include a prime mover, e.g., an internal combustion engine, and an associated drivetrain, e.g., a transmission, drive shaft, differential gearing, axle shafts, etc., coupled to the ground engaging elements 44. The propulsion system 46 is operable to drive or move the ground engaging elements 44 to control a ground speed of the traction unit 24. The specific features and operation of the propulsion system 46 are known to those skilled in the art, are not pertinent to the teachings of this disclosure, and are therefore not described in greater detail herein.

The traction unit 24 may include a speed sensor 52. The speed sensor 52 is operable to detect data related to the ground speed of the traction unit 24. The speed sensor 52 may be configured and operate in a manner that is capable of sensing data related to the ground speed of the traction unit 24. For example, the speed sensor 52 may sense a rotational speed of a rotating element of the propulsion system 46. In another embodiment, the speed sensor 52 may include a location sensor 54, such as but not limited to a Global Positioning Sensor system, which is operable to track a ground location of the traction unit 24 over a period of time, and thereby determine the ground speed of the traction unit 24. It should be appreciated that the speed sensor 52 may differ from the exemplary implementations described herein. The speed sensor 52 may be in communication with a controller 56, described in greater detail below, and communicate the sensed data to the controller 56.

The steering system 48 may include a steering input device, e.g., a steering wheel or track levers, motors, linkages, tie rods, hydraulics, etc., and be coupled to one or more of the ground engaging elements 44 to control the direction of travel 36 of the traction unit 24. The steering system 48 may include any system capable of turning the traction unit 24 about a vertical axis to change the direction of travel 36 of the traction unit 24. The specific features and operation of the steering system 48 are known to those skilled in the art, are not pertinent to the teachings of this disclosure, and are therefore not described in greater detail herein.

The traction unit 24 may include a steering angle sensor 60. The steering angle sensor 60 is operable to detect data related to a current position and/or orientation of the steering system 48. The current position of the steering system 48 may be combined with the ground speed of the traction unit 24 to determine a rate of turn of the traction unit 24. The steering angle sensor 60 may be configured and operate in a manner that is capable of sensing data related to the current operation of the steering system 48 and/or to the rate of turn of the traction unit 24. For example, the steering angle sensor 60 may include a position sensor for detecting an angular position of the steering wheel or a position of a steering gear. In another implementation, the steering angle sensor 60 may include the location sensor 54, such as but not limited to a Global Positioning Sensor system, which is operable to track a ground location of the traction unit 24 over a period of time, and thereby determine a rate of turn of the traction unit 24. It should be appreciated that the steering angle sensor 60 may differ from the exemplary implementations described herein. The steering angle sensor 60 may be in communication with the controller 56, described in greater detail below, and communicate the sensed data to the controller 56.

The lift system 50 may include, but is not limited to, an actuator that may be controlled and is operable to control a vertical position of the implement head 26 relative to the traction unit 24. In one implementation, the lift system 50 may include an actuator and associated linkages connecting the implement head 26 and the chasses. The actuator may include an electric actuator, a pneumatic actuator, a hydraulic actuator, etc. For example, the lift system 50 may include a hydraulic system operable to extend and/or retract one or more hydraulic cylinders. The hydraulic cylinders are coupled to and interconnect, either directly or indirectly, the implement head 26 and the chassis 42. The hydraulic cylinders may be controlled to raise and/or lower the implement head 26 relative to the ground surface. The specific features and operation of the lift system 50 are known to those skilled in the art, are not pertinent to the teachings of this disclosure, and are therefore not described in greater detail herein.

The traction unit 24 may further include the location sensor 54. The location sensor 54 may be disposed in communication with the controller 56. The location sensor 54 is operable to sense data related to one of a geographic location of the traction unit 24 and/or a ground speed of the traction unit 24 relative to the implement placement location 74. In one implementation, the location sensor 54 may include a Global Positioning Satellite (GPS) sensor that receives data signals from multiple satellites, and uses the data signal to determine a geographic location. The determined geographic location may be tracked over time to determine a ground speed of the traction unit 24. It should be appreciated that the location sensor 54 may differ from the example implementation noted herein. The specific features and operation of the location sensor 54 are known to those skilled in the art, are not pertinent to the teachings of this disclosure, and are therefore not described in greater detail herein.

The trailer 28 is configured to receive and support the implement head 26 for transportation of the implement head 26 between locations, e.g., between fields. The trailer 28 may be coupled to and drawn by the traction unit 24. In other embodiments, the trailer 28 may be coupled to and drawn by another tow vehicle, such as but not limited to a truck or similar moveable platform.

The trailer 28 includes a frame 62. The frame 62 rotatably supports one or more ground engaging elements 64, such as but not limited to tires, and a hitch system 66 for connecting to either the traction unit 24 or another tow vehicle. The frame 62 may include any frame 62 rails, cross members, panels, supports, brackets, latches, etc., necessary to support the implement head 26. The frame 62 may be sized to include a load area length 68 and a load area width 70 sufficient to support the head length 38 and the head width 40 of the implement head 26. As used herein, the load area length 68 and the load area width 70 of the trailer 28 are defined relative to a direction of travel of the trailer 28 when transporting the implement head 26. As such, with the implement head 26 loaded on the trailer 28, the load area length 68 of the trailer 28 is parallel with the head width 40 of the implement head 26 as defined herein, and the load area width 70 of the trailer 28 is parallel with the head length 38 of the implement head 26 as defined herein.

In some implementations, the trailer 28 may include a marker 72 that is disposed on the frame 62. If so equipped, the marker 72 may include data defining and/or related to an implement placement location 74 on the frame 62. The implement placement location 74 may be defined as a three-dimensional spot or point location relative to the frame 62. However, in other implementations, the implement placement location 74 may be defined as an implement boundary region 76 on the frame 62. As such, the marker 72 may include data related to a three-dimensional location of the implement boundary region 76. The implement boundary region 76 may be defined herein as a position or area on the frame 62 configured for supporting the implement head 26. For example, in one implementation, the implement boundary region 76 may correspond to an exterior periphery of the implement head 26.

The marker 72 may include a device capable of communicating data and/or information related to the implement placement location 74 and/or the implement placement boundary to a trailer sensor 78 and/or an operator. It should be appreciated that the marker 72 may include a plurality of markers 72 positioned around the frame 62, and which cooperate to provide data related to a two- or three-dimensional location relative to the frame 62 of the trailer 28. In one implementation, the marker 72 may include a visual fiducial marker 72 indicating a three-dimensional location relative to the frame 62. The visual fiducial marker 72 may include, but is not limited to, an AprilTag™, or other similar device as understood by those skilled in the art. In another implementation, the marker 72 may include one or more RFID tags or other wireless data transmission devices that are operable to transmit data to a receiver related to the implement placement location 74 and/or the implement placement boundary relative to the frame 62.

The traction unit 24 may further include a trailer sensor 78. The trailer sensor 78 is positioned to detect data from the trailer 28. In one implementation, the trailer sensor 78 may be positioned to detect data from the marker 72 as the forward end 32 of the traction unit 24 approaches the trailer 28. The trailer sensor 78 may be operable to detect the data from the marker 72 related to the implement placement location 74 and/or the implement placement boundary. The trailer sensor 78 is disposed in communication with the controller 56 for communicating the data sensed from the marker 72 to the controller 56. In another implementation, for example, if the trailer is not equipped with the marker 72, the trailer sensor 78 may detect data from the frame 62. For example, the trailer sensor 78 may capture an image of the frame 62 showing the shape, size, orientation, position, construction, etc., of the different components and/or features forming the frame 62.

The specific type and operation of the trailer sensor 78 is dependent upon whether the trailer 28 is or is not equipped with the marker 72, and if equipped with the marker 72, with the specific type and operation of the marker 72. In one implementation, the marker 72 includes the visual fiducial marker 72, and the trailer sensor 78 includes an optical sensor. For example, the optical sensor may include one or more cameras. For example, in one implementation, the optical sensor may include a stereo camera or multiple non-stereo cameras arranged to detect images from different perspectives. In another implementation, the mark includes a wireless electronic communication device, such as but not limited to an RFID tag, and the trailer sensor 78 includes a reader, such as but not limited to an RFID reader. It should be appreciated that the trailer sensor 78 may differ from the example implementations described herein. In yet another implementation, if the trailer 28 is not equipped with the marker 72, the trailer sensor 78 may include an optical sensor that is operable to capture an image of the frame 62 of the trailer 28.

As noted above, the traction unit 24 may include the controller 56. The controller 56 may be disposed in communication with one or more of the trailer sensor 78, the location sensor 54, the steering angle sensor 60, the speed sensor 52, the propulsion system 46, the steering system 48, the lift system 50, and/or a visual display 80. The controller 56 is operable to receive data from the sensors, and output a control signal to one or more of the operating systems 46, 48, 50 and/or the visual display 80. While the controller 56 is generally described herein as a singular device, it should be appreciated that the controller 56 may include multiple devices linked together to share and/or communicate information therebetween. Furthermore, it should be appreciated that the controller 56 may be located on the traction unit 24 or located remotely from the traction unit 24.

The controller 56 may alternatively be referred to as a computing device, a computer, a control unit, a control module, a module, etc. The controller 56 includes a processor 82, a memory 84, and all software, hardware, algorithms, connections, sensors, etc., necessary to manage and control the operation of the traction unit 24 and the implement head 26. As such, a method may be embodied as a program or algorithm operable on the controller 56. It should be appreciated that the controller 56 may include any device capable of analyzing data from various sensors, comparing data, making decisions, and executing the required tasks.

As used herein, “controller” is intended to be used consistent with how the term is used by a person of skill in the art, and refers to a computing component with processing, memory, and communication capabilities, which is utilized to execute instructions (i.e., stored on the memory 84 or received via the communication capabilities) to control or communicate with one or more other components. In certain embodiments, the controller 56 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The controller 56 may be in communication with other components on the traction unit 24, the trailer 28, and/or the implement head 26, such as hydraulic components, electrical components, and operator inputs within an operator station of an associated work vehicle. The controller 56 may be electrically connected to these other components by a wiring harness such that messages, commands, and electrical power may be transmitted between the controller 56 and the other components. Although the controller 56 is referenced in the singular, in alternative embodiments the configuration and functionality described herein can be split across multiple devices using techniques known to a person of ordinary skill in the art.

The controller 56 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 84 may include any non-transitory/tangible medium which participates in providing data or computer-readable instructions. The memory 84 may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The controller 56 includes the tangible, non-transitory memory 84 on which are recorded computer-executable instructions, including an unloading algorithm 86. The processor 82 of the controller 56 is configured for executing the unloading algorithm 86. The unloading algorithm 86 implements a method of unloading the implement head 26 from the traction unit 24 onto the trailer 28, described in detail below.

The method of unloading the implement head 26 onto the trailer 28 includes sensing data from the trailer 28 with the trailer sensor 78 disposed on the traction unit 24. As described above, the data from the trailer 28 relates to the implement placement location 74 on the trailer 28. The data from the trailer 28 may be sensed as the traction unit 24 and the trailer sensor 78 approach the trailer 28 to unload the implement head 26. The data may include, but is not limited to, data associated with the marker 72, or may include an image of the construction of the frame 62 of the trailer.

The data sensed from the trailer 28, e.g., the marker 72, is related to the implement placement location 74 on the frame 62. In one implementation, the implement placement location 74 may include a point or spot location on the frame 62 of the trailer 28. In another implementation, the implement placement location 74 may include the implement boundary region 76. As described above, the implement boundary region 76 may include or define an area on the frame 62 of the trailer 28 corresponding to an exterior or outer periphery of the implement head 26. If the implement boundary location includes the implement boundary region 76, then the controller 56 may determine a placement center location 88 of the implement boundary region 76. The placement center location 88 of the implement boundary region 76 may be defined as a center 90 location of the implement boundary region 76 that corresponds to a center 90 of the implement head 26. The implement head 26 may be positioned on the trailer 28 such that the center 90 of the implement head 26 is aligned on top of the center 90 location of the implement boundary region 76, thereby positioning the implement head 26 within the implement boundary region 76.

The controller 56 may then determine a position of the implement head 26 relative to the implement placement location 74. Determining the position of the implement head 26 may include determining the location of the center 90 of the implement head 26. The center 90 of the implement head 26 may be aligned with the center 90 location of the implement placement location 74 to properly position the implement head 26 on the trailer 28. The center 90 of the implement head 26 may be defined based on the location of the traction unit 24, or based on the location of a specific feature or component of the traction unit 24. The controller 56 may determine the center 90 of the implement head 26 using data from the location sensor 54 of the traction unit 24.

The controller 56 may further determine a ground speed of the traction unit 24 relative to the trailer 28, using data from the sped sensor, and/or a direction of travel 36 of the traction unit 24 relative to the trailer 28 using data from the steering angle sensor 60 and/or the location sensor 54. The controller 56 may use the data from the marker 72 related to the implement placement location 74 and/or the implement placement region, the location of the implement head 26 relative to the trailer 28, the ground speed of the traction unit 24, and/or the direction of travel 36 of the traction unit 24 relative to the trailer 28 to generate a guide signal. The guide signal may be used to guide the traction unit 24 relative to the trailer 28 to position the implement head 26 on the implement placement location 74 of the frame 62 when transferring the implement head 26 from the traction unit 24 to the trailer 28.

The guide signal includes guidance to position the implement head 26 within the implement boundary region 76, such that the placement center location 88 of the implement head 26 is positioned on the placement center location 88 of the implement boundary region 76. In one implementation, the guide signal may include a control signal for controlling one or more of the operating systems 46, 48, 50 of the traction unit 24, i.e., one or more of, but not limited to, the propulsion system 46, the steering system 48 and/or the lift system 50. In another implementation, the guide signal may include a communication signal for a visual display 80.

If the guide signal includes the control signal for controlling one or more of the operating systems 46, 48, 50 of the traction unit 24, then the controller 56 may automatically communicate the control signal to the appropriate operating system 46, 48, 50 to automatically control that operating system 46, 48, 50. For example, the controller 56 may automatically control the propulsion system 46 to move forward at a desired ground speed, while controlling the steering system 48 to properly position the traction unit 24 and the implement head 26 relative to the trailer 28 such that the implement head 26 is aligned with the placement location on the trailer 28. Alternatively, the controller 56 may determine and/or define the control signal for the operating systems 46, 48, 50, and then request authorization from an operator to implement and/or communicate the control signal to the appropriate operating system 46, 48, 50.

As noted above, in one implementation, the guide signal may include a communication signal for the visual display 80. The visual display 80 may be positioned within an operator's station or cab 92 of the traction unit 24. The visual display 80 is operable to communicate with the operator of the traction unit 24. The communication signal may be configured to communicate an operating command to the operator of the traction unit 24. For example, the communication signal may communicate a specific operating command for moving the traction unit 24 along a highlighted path, an operating command to turn left or right, etc. The operator may then execute the operating command presented on the visual display 80 from the communication signal. By following the operating commands communicated by the communication signal, the operator of the traction unit 24 may quickly and easily position the implement head 26 properly over the implement placement location 74 of the trailer 28.

As described above, if the guide signal includes a control signal for one of the operating systems 46, 48, 50 of the traction unit 24, then the controller 56 may automatically implement the control signal or implement the control signal with authorization from the operator. Alternatively, if the guide signal is configured as the communication signal, then the operator may control the operating systems 46, 48, 50 of the traction unit 24 based on the communication signal. With either implementation, the traction unit 24 is maneuvered in response to the guide signal to position the implement head 26 on or over the implement placement location 74 of the trailer 28, such that the implement head 26 is properly positioned above the trailer 28 with respect to both the length and the width of the trailer 28.

Once the implement head 26 is properly positioned over or above the implement placement location 74 on the trailer 28, the lift system 50 may be engaged to lower the implement head 26 onto the trailer 28. The lift system 50 may be engaged and controlled automatically by the controller 56, by the controller 56 in response to authorization from the operator, or may be manually controlled by the operator. The implement head 26 is lowered onto the trailer 28 such that the trailer 28 supports the full weight of the implement head 26. Once the implement head 26 is supported on the frame 62 of the trailer 28, the implement head 26 may be detached from the traction unit 24 to complete the transfer of the implement head 26 onto the trailer 28, and the traction unit 24 withdrawn away from the trailer 28. The trailer 28, with the implement head 26 secured thereto, may then be moved from one location to another without violating any roadway width restrictions between the locations.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. An implement head transportation system comprising;
an implement head;
a traction unit configured to receive and support the implement head for operation of the implement head;
a trailer configured to receive and support the implement head for transportation of the implement head between locations;
wherein the trailer includes a frame;
wherein the traction unit includes a controller including a processor and a memory having an unloading algorithm stored therein, wherein the processor is operable to execute the unloading algorithm to:
sense data from the trailer;
determine an implement placement location from the data sensed from the trailer; and
generate a guide signal for guiding the traction unit relative to the trailer to position the implement head on the implement placement location of the frame when transferring the implement head from the traction unit to the trailer.

2. The implement head transportation system set forth in claim 1, wherein the frame includes a marker including information related to the implement placement location on the frame.

3. The implement head transportation system set forth in claim 2, wherein the marker includes a visual fiducial marker indicating a three-dimensional location relative to the frame.

4. The implement head transportation system set forth in claim 2, wherein the processor is operable to execute the unloading algorithm to sense the data from the marker related to the implement placement location.

5. The implement head transportation system set forth in claim 1, wherein the implement placement location includes an implement boundary region corresponding to an exterior periphery of the implement head.

6. The implement head transportation system set forth in claim 5, wherein the marker includes data related to a three-dimensional location of the implement boundary region.

7. The implement head transportation system set forth in claim 6, wherein the processor is operable to execute the unloading algorithm to determine a placement center location of the implement boundary region.

8. The implement head transportation system set forth in claim 7, wherein the processor is operable to execute the unloading algorithm to determine a placement center location of the implement head.

9. The implement head transportation system set forth in claim 8, wherein the guide signal includes guidance to position the implement head within the implement boundary region, such that the placement center location of the implement head is positioned on the placement center location of the implement boundary region.

10. The implement head transportation system set forth in claim 1, wherein the traction unit includes a trailer sensor in communication with the controller and positioned to detect the data from the trailer.

11. The implement head transportation system set forth in claim 10, wherein the trailer sensor includes an optical sensor.

12. The implement head transportation system set forth in claim 11, wherein the optical sensor includes a stereo camera.

13. The implement head transportation system set forth in claim 1, wherein the traction unit includes a location sensor in communication with the controller and operable to sense data related to one of a geographic location of the traction unit and a ground speed of the traction unit relative to the implement placement location.

14. The implement head transportation system set forth in claim 13, wherein the location sensor includes a Global Positioning Satellite sensor.

15. The implement head transportation system set forth in claim 1, wherein the guide signal includes a communication signal for a visual display configured to communicate an operating command to an operator of the traction unit.

16. The implement head transportation system set forth in claim 1, wherein the guide signal includes a control signal for controlling an operating system of the traction unit.

17. The implement head transportation system set forth in claim 16, wherein the operating system includes one of a propulsion system operable to control a ground speed of the traction unit, a steering system operable to control a direction of travel of the traction unit, and a lift system operable to control a vertical position of the implement head relative to the traction unit.

18. The implement head transportation system set forth in claim 17, wherein the traction unit includes a steering angle sensor operable to detect data related to a current position of the steering system.

19. The implement head transportation system set forth in claim 17, wherein the traction unit includes a speed sensor operable to detect data related to the ground speed of the traction unit.

20. A trailer for transporting an implement head of a harvester implement, the trailer comprising:
a frame;
a marker disposed on the frame, the marker including data defining an implement boundary region on the frame, wherein the implement boundary region is a position on the frame configured to supporting the implement head.

21. The trailer set forth in claim 18, wherein the marker includes a visual fiducial marker indicating a three-dimensional location relative to the frame.

22. A traction unit for a harvester implement, the traction unit comprising:
a chassis rotatably supporting a ground engaging element, wherein the chassis is configured to receive and support an implement head;
a propulsion system operable to rotate the ground engaging element for moving the chassis relative to ground surface at a ground speed;
a steering system operable to control a direction of travel of the chassis;
a lift system operable to control a vertical height of the implement head relative to the ground surface;
a controller including a processor and a memory having an unloading algorithm stored therein, wherein the processor is operable to execute the unloading algorithm to:
sense data from the trailer;
determine an implement placement location from the data from the trailer;
generate a guide signal for guiding the chassis relative to the trailer to position the implement head on the implement placement location of the trailer when transferring the implement head from the chassis to the trailer.

23. The traction unit set forth in claim 22, further comprising a trailer sensor operable to sense the data from the trailer.

24. The traction unit set forth in claim 23, wherein the trailer sensor includes a stereo camera.

25. A method of unloading an implement head from a traction unit onto a trailer, the method comprising:
sensing data from the trailer with a trailer sensor disposed on the traction unit, wherein the data from the trailer relates to an implement placement location on the trailer;
determining a position of the implement head relative to the implement placement location with a location sensor disposed on the traction unit; and
generating a guide signal with a controller of the traction unit, wherein the guide signal is configured to guide the traction unit relative to the trailer to position the implement head on the implement placement location of the frame when transferring the implement head from the traction unit to the trailer.

26. The method set forth in claim 25, further comprising maneuvering the traction unit in response to the guide signal to position the implement head on the implement placement location of the trailer.

27. The method set forth in claim 26, further comprising lowering the implement head onto the trailer via a lift system of the traction unit.

28. The method set forth in claim 27, further comprising detaching the implement head from the traction unit to transfer support of the implement head from the traction unit to the trailer.

29. The method set forth in claim 25, wherein the trailer includes a marker including data related to the implement placement location.

30. The method set forth in claim 29, wherein the marker includes a visual fiducial marker indicating a three-dimensional location relative to the trailer.

31. The method set forth in claim 30, wherein the implement placement location includes an implement boundary region corresponding to an exterior periphery of the implement head.

32. The method set forth in claim 31, wherein the marker includes data related to a three-dimensional location of the implement boundary region.

33. The method set forth in claim 31, further comprising determining a placement center location of the implement boundary region on the trailer.

34. The method set forth in claim 33, further comprising determining a placement center location of the implement head.

35. The method set forth in claim 34, wherein the guide signal is configured to guide the traction unit relative to the trailer such that the placement center location of the implement head is aligned with the placement center location of the implement boundary region on the trailer.

36. The method set forth in claim 25, wherein the guide signal includes a communication signal for a visual display of the traction unit, wherein the communication signal is configured to communicate an operating command via the visual display to an operator of the traction unit.

37. The method set forth in claim 25, wherein the guide signal includes a control signal for automatically controlling an operating system of the traction unit.

38. The method set forth in claim 37, wherein the operating system includes one of a propulsion system operable to control a ground speed of the traction unit, a steering system operable to control a direction of travel of the traction unit, and a lift system operable to control a vertical position of the implement head relative to the traction unit.

39. The method set forth in claim 25, further comprising determining a ground speed of the traction unit relative to the trailer.

40. The method set forth in claim 25, further comprising determining a direction of travel of the traction unit relative to the trailer.
